(19) United States
(12) Patent Application Publication
(10) Pub. No.: US 2008/0278602 A1
(43) Pub. Date: Nov. 13, 2008

(54) CAMERA

(75) Inventor: Hironao Otsu, Tokyo (JP)

Correspondence Address: VOLPE AND KOENIG, P.C., UNITED PLAZA, SUITE 1600, 30 SOUTH 17TH STREET, PHILADELPHIA, PA, 19103, US

(73) Assignee: Olympus Corporation, Tokyo (JP)

(21) Appl. No.: 12/118,087

(22) Filed: May 9, 2008

(30) Foreign Application Priority Data
May 10, 2007 (JP) 2007-125618

(51) Int. Cl. H04N 9/73

(52) U.S. Cl. 348/223.1

(57) ABSTRACT

A camera includes an optical system, an image sensor, a white balance correction section, an original image processing section, a geometric setting section which sets a desired geometric transformation for the original picture signal, a geometry converter which generates a geometrically converted picture signal based on the geometric setting made by the geometric setting section, an edge component extractor, an edge signal generator, and an image synthesizer which synthesizes the geometrically converted picture signal and signal at the edges to generate a picture signal. The edge signal generator performs geometrical transformation of the edges of the image based on the geometric setting and is parameter-controlled based on a geometry parameter computed from a coefficient to emphasize edges for controlling the enhancement at the edges amount for the edges of the image and magnification to zoom an image calculated based on the geometric setting.

### CROSS-REFERENCE TO RELATED APPLICATIONS

This application is based upon and claims the benefit of priority from prior Japanese Patent Application No. 2007-125618, filed May 10, 2007, the entire contents of which are incorporated herein by reference.

### BACKGROUND OF THE INVENTION

1. Field of the Invention

The present invention relates to a camera for generating a signal at the edges from a captured image based on a geometric setting.

2. Description of the Related Art

A technique relating to a video camera is disclosed in, e.g., Jpn. Pat. Appln. KOKAI Publication No. 11-239294. This publication describes a video camera provided with an electronic zoom function including: an image capture means for focusing a targeting object image and outputting a video signal based on the focused image; a high-frequency component extraction means for extracting a high-frequency component of the video signal; a gain setting means for setting a gain in the high-frequency component of the video signal extracted by the high-frequency component extraction means; an adding means for adding the high-frequency component in which the gain is set by the gain setting means to the video signal; a camera picture signal output means for outputting a camera picture signal based on the image processed video signal output from the adding means; and a control means for controlling the setting of the gain performed by the gain setting means based on the operating characteristics of the video camera and zoom magnification factor.

Further, Jpn. Pat. Appln. KOKAI Publication No. 2003-8889 discloses a technique relating to an image processing apparatus including: an image capture means for capturing an image, applying first image processing including image detail correction to the captured image data, and outputting the image data subjected to the first image processing; a magnification processing means for applying second image processing including magnification processing to the image data output from the image capture means and displaying the image data subjected to the second image processing; and an magnification factor setting means for setting the magnification factor in the magnification processing means. Upon receiving a specified magnification factor from the magnification factor setting means, the magnification processing means once stops the detail correction processing of the image capture means and restarts the detail correction processing after applying magnification processing to the image data output from the image capture means.

Further, Jpn. Pat. Appln. KOKAI Publication No. 2000-101870 discloses a technique related to a digital signal processing circuit including: a means for interpolating pixels into an input video signal to convert the number of pixels; a means for generating a control signal from a high-frequency range signal of the input video signal; and a control means for controlling the phase of the interpolated pixels using the control signal.

Among cameras for recording a captured image and/or displaying the captured image, there is known one provided with a function of geometry conversion an electronically output signal from image sensor obtained by photoelectric converting an optic image by image processing computation. The geometric transformation includes various application forms according to purpose such as electronic zoom (magnification), electronic camera shake correction (magnification and rotation), optical distortion correction, and aspect ratio conversion (horizontal magnification or vertical magnification).

However, in the case where the substantial number of luminance samples of a captured image is insufficient relative to the number of recorded pixels of the captured image or the number of displayed pixels thereof (number of pixels per unit area is less than that of original one), the captured image is inevitably recorded or displayed with a degraded resolution.

The reason for this is that the degradation in the resolution of the picture due to the insufficient number of luminance samples depends on the sampling theorem, so that it is impossible to restore original resolution of the picture by means of general image processing unless resolution information is added by retouching processing.

In the case where the resolution of the picture degrades due to the insufficient number of luminance samples after application of the abovementioned geometric transformation, apparent resolution or sharpness of the captured image is impaired from the viewpoint of the visual feature of human eyes (first problem).

As a typical method for improving the first problem, there is known a method of simply amplifying the amplitude level of edges of the image of the captured image so as to generate a signal at the edges for the purpose of improving the apparent resolution or sharpness of the captured image.

However, even though the above method can improve the apparent resolution or sharpness of the captured image by simply amplifying the amplitude level of edges of the image, these edges of the image becomes a bold line when the captured image is magnified with the result that the bold line is unnaturally emphasized (second problem).

As a precondition, the geometric transformation (image magnification based on assistant pixels interval) according to the present invention is implemented in a camera and, therefore, a result of the geometric transformation needs to be visually confirmed in substantially a real-time manner through an electronic viewfinder (EVF) or a small-sized monitor provided in the camera before and during recording of the captured image.

In the case of a geometric transformation apparatus like a computer graphics (CG apparatus), a large-scale circuit and long time may be used to perform computation for image processing (which may include retouching processing and the like) after recording of the captured image. In such a CG apparatus, with respect to the image duality after geometric transformation, the abovementioned first and second problems have been solved.

However, in the abovementioned CG apparatus, a problem (third problem) that a geometric transformation apparatus should achieve high-speed image processing when it is incorporated in a camera is not solved. That is, this CG apparatus does not satisfy requirements, such as being moderate in price, having a small-scale circuit, having a smaller time lag between capturing of an optic image and display of the captured image, which are necessary for the geometric transformation apparatus to be incorporated in a camera.

In order to cope with the abovementioned problems, there is known a technique disclosed in Jpn. Pat. Appln. KOKAI Publication No. 11-239294. This publication discloses a video camera is provided with a control means that controls setting of the gain in a high-frequency component of a video signal based on the SN ratio of the video signal, amount of a folding component associated with optical sampling, and electronic zoom magnification factor.

In the video camera disclosed in Jpn. Pat. Appln. KOKAI Publication No. 11-239294, the first problem that the apparent resolution or sharpness of a captured image is impaired and third problem that a geometric transformation apparatus should achieve high-speed image processing when it is incorporated in a camera have been solved. However, the second problem that edges of the image of a captured image is unnaturally emphasized as a bold line has not yet been solved.

This is because that the frequency of a high-frequency component of the video signal in the video camera disclosed in Jpn. Pat. Appln. KOKAI Publication No. 11-239294 is decreased in reverse proportion to the electronic zoom magnification factor and, when the decreased high frequency component is multiplied by a gain, apparent unnaturalness is emphasized.

In the image processing apparatus disclosed in Jpn. Pat. Appln. KOKAI Publication No. 2003-8889, the camera does not perform the detail correction processing immediately after when receiving the magnification factor specified by the magnification factor setting means but performs it after application of image magnification processing, whereby a high-quality image in which the edge line of the image is not excessively emphasized even if the entire image is magnified can be obtained.

However, the image processing apparatus disclosed in Jpn. Pat. Appln. KOKAI Publication No. 2003-8889 can prevent the edge line emphasized by the detail correction processing from being expanded by performing the detail correction processing after the image magnification processing, while edges of the image (transient area of edge line) that has already been contained in the captured image must be a part of the image, so that the width of the edges of the image is expanded in proportion to the magnification factor of the image magnification processing.

For the above reason, in the image processing apparatus disclosed in Jpn. Pat. Appln. KOKAI Publication No. 2003-8889, the effect of suppressing expansion of the signal at the edges generated from edges of the image is limited to only the enhancement at the edges portion and is not expected to occur for the expansion of the edges of the image. Thus, in the image processing apparatus, the second problem that edges of the image of a captured image is unnaturally emphasized as a bold line has not yet been solved.

The abovementioned digital signal processing circuit disclosed in Jpn. Pat. Appln. KOKAI Publication No. 2000-101870 is configured to control the phase of interpolated pixels using a control signal generated from a high-frequency signal of an input video signal.

The digital signal processing circuit controls the phase of interpolated pixels by using a control signal generation means which is constituted by: a means for extracting a primary differential signal of an input video signal; a means for extracting a secondary differential signal; a first conversion means for converting the number of pixels of the primary differential signal; a second conversion means for converting the number of pixels of the secondary differential signal; and a means for inverting the code of an output signal from the first conversion means using an output signal from the second conversion means, whereby even in the case where pixels are interpolated into an input video signal to convert the number of pixels, edges of the image of the captured image is not emphasized as a bold line.

However, in the digital signal processing circuit disclosed in Jpn. Pat. Appln. KOKAI Publication No. 2000-101870, the third problem that a geometric transformation apparatus should achieve high-speed image processing when it is incorporated in a camera has not been solved.

This is because that, in the phase control of the interpolated pixels performed by the digital signal processing circuit, image processing based on a local nearest neighbor method is applied to edges of the image (transient area of edge line) of the image, and this control processing is based on an image processing algorism using the extracted primary and secondary differential signals of the input video signal.

As described above, the digital signal processing circuit disclosed in Jpn. Pat. Appln. KOKAI Publication No. 2000-101870 needs to incorporate an image analyzing circuit for analyzing an input video signal in order to perform the phase control of the interpolated pixels, inevitably increasing the circuit scale with the result that a high-speed image processing cannot be performed.

Assuming that the digital signal processing circuit disclosed in Jpn. Pat. Appln. KOKAI Publication No. 2000-101870 is provided on the assumption that a function of magnifying a captured image is incorporated in a camera, a concrete high-speed control method for visually conforming a result of the magnification processing in substantially a real-time manner through an electronic viewfinder (EVF) before and during recording of the captured image is not mentioned in this publication.

### BRIEF SUMMARY OF THE INVENTION

The present invention has been made in view of the abovementioned problem and an object of the present invention is to provide a camera capable of improving apparent resolution or sharpness of a captured image in the case where resolution of the picture degrades due to application of geometric transformation of the captured image.

Another object of the present invention is to provide a camera capable of alleviating expansion of the width of edges of the image in association with magnification (including magnification of a part of a captured image) of the entire captured image due to application of geometric transformation so as to prevent the edges of the image of the captured image from being unnaturally be emphasized as a bold line image.

Still another object of the present invention is to provide a camera incorporating a geometric transformation apparatus which is moderate in price, which has a small-scale circuit, and which has a smaller time lag between capturing of an optic image and display of the captured image so as to visually confirm a result of geometric transformation in substantially a real-time manner through an electronic viewfinder (EVF) or a small-sized monitor provided in the camera before and during recording of the captured image.

That is, an object of the present invention is to provide a camera comprising: an optical section which generates an optic image from a targeting object; an image sensor which photoelectric converts the optic image to generate a output signal from image sensor; a white balance correction section which corrects the white balance of the captured signal to generate a white balanced imaging signal; an original image processing section which generates an original picture signal from the white balanced imaging signal; a geometric setting section which sets a desired geometric transformation for the original picture signal; a geometry converter which generates a geometrically converted picture signal based on the geometric setting made by the geometric setting section; edges of the image extractor which extracts edges of the image from the captured image; a signal at the edges generator which generates a signal at the edges from the edges of the image; and an image synthesizer which synthesizes the geometrically converted picture signal and signal at the edges to generate an picture signal, wherein the signal at the edges generator performs geometrical transformation of the edges of the image based on the geometric setting and is parameter-controlled based on a geometry parameter computed from a coefficient to emphasize edges for controlling the enhancement at the edges amount for the edges of the image and magnification to zoom an image calculated based on the geometric setting.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a configuration of a camera 10 according to a first embodiment of the present invention;

FIG. 2 is a conceptual view showing a relationship among an optic image of a typical pattern chart having a light shielding portion and an opening portion, a partially shown image sensor composed of a matrix of 5 (H)×4 (V), and a graph representing the transmittance (%) of the pattern chart with respect to the horizontal phase (μm) of the image sensor;

FIG. 3 is a graph representing the contrast (%) of a captured image generated by the horizontally arranged five pixels (H) denoted by the frame a in FIG. 2;

FIG. 4 is a graph representing the contrast (%) of a signal at the edge c whose phase is doubled in the horizontal direction by applying assistant pixels interval to the output signal from image sensor b shown in FIG. 3 according to a typical bicubic assistant pixels interval formula;

FIG. 5 is a graph representing, in a superimposed manner, the contrast (%) of a signal at the edges d which is obtained by applying the assistant pixels interval according to a typical bicubic assistant pixels interval formula to the output signal from image sensor shown in FIG. 3 and contrast (%) of a signal at the edges f which is obtained by assistant pixels interval according to a typical bilinear assistant pixels interval formula thereto;

FIG. 6 is a graph representing, in a superimposed manner, the contrast (%) of a signal at the edges g obtained by assistant pixels interval based on parameter control in the first embodiment of the present invention and contrast (%) of a signal at the edges f which is obtained by assistant pixels interval according to the typical bilinear assistant pixels interval formula;

FIG. 7 is a graph representing, in a superimposed manner, the contrast (%) of a signal at the edges h obtained by assistant pixels interval based on enhancement at the edges type parameter control in the first embodiment and contrast (%) of a signal at the edges f which is obtained by assistant pixels interval according to the typical bilinear assistant pixels interval formula;

FIG. 8 is a graph representing, in a superimposed manner, the contrast (%) of a signal at the edges i obtained by the enhancement at the edges based on the enhancement at the edges type parameter in the present embodiment which is shown in FIG. 7 and contrast (%) of a signal at the edges j which is obtained by a typical enhancement at the edges (bold line);

FIG. 9 is a graph representing, in a superimposed manner, the contrast (%) of a signal at the edges i obtained by the enhancement at the edges based on the enhancement at the edges type parameter in the present embodiment which is shown in FIG. 7 and contrast (%) of a signal at the edges k which is obtained by applying enhancement at the edges after image magnification processing;

FIG. 10 is a conceptual view showing a relationship among an optic image of a typical pattern chart having a light shielding portion and an opening portion, a partially shown image sensor composed of a matrix of 5 (H)×4 (V), and a graph representing the transmittance (%) of the pattern chart with respect to the horizontal phase (μm) of the image sensor, which shows a case where the boundary line between the light shielding portion and opening portion of the pattern chart substantially corresponds to the boundary line between adjacent pixels on the image sensor;

FIG. 11 is a graph representing, in a superimposed manner, the contrast (%) of a signal at the edges m which is obtained based on horizontal assistant pixels interval value Ic (x) according to the typical bicubic type assistant pixels interval formula and contrast (%) of a signal at the edges n which is obtained based on horizontal assistant pixels interval value IL (x) according to the typical bilinear type assistant pixels interval formula under the image capture condition shown in the conceptual view of FIG. 10;

FIG. 12 is a graph representing, in a superimposed manner, the contrast (%) of a signal at the edges p which is obtained based on the horizontal assistant pixels interval value I (x) according to the first embodiment in the case of FIG. 6 where the edges of the image is captured by three pixels and contrast (%) of a signal at the edges q which is obtained based on the horizontal assistant pixels interval value I (x) according to the present invention in the case of FIG. 11 where the edges of the image is captured by two pixels;

FIG. 13 is a graph showing a relationship between the relative position (%) of a captured image based on the magnification to zoom an image (×z) and contrast (%) of the signal at the edges according to the first embodiment;

FIG. 14 is a graph showing a relationship between the relative position (%) of a captured image based on the magnification to zoom an image (×z) and contrast (%) of the signal at the edges according to the present embodiment, in which the magnification to zoom an image z in the geometry parameter P (e,z) is set to 3 or less;

FIG. 15 is a block diagram showing a configuration of a camera 30 according to the second embodiment of the present invention;

FIG. 16 is a view showing a relationship among an optic image of a typical pattern chart having a light shielding portion and an opening portion, a partially shown image sensor composed of a matrix of 5 (H)×4 (V), and G pixels arranged on the image sensor;

FIG. 17 is a view showing a relationship between an optic image of a typical pattern chart having a light shielding portion and an opening portion, a typical image sensor composed of a matrix of (H)×4 (V), and G pixels arranged on the image sensor, which shows a case where the boundary line between the light shielding portion and opening portion of the pattern chart does not exist on the G pixel contained in a frame r;

FIG. 18 is a view showing a relationship between an optic image of a typical pattern chart having a light shielding portion and an opening portion, a typical image sensor composed of a matrix of 5 (H)×4 (V), and G pixels arranged on the image sensor, which shows a case where the boundary line between the light shielding portion and opening portion of the pattern chart does not exist on the G pixel contained in a frame r;

FIG. 19 is a view showing a relationship between an optic image of a typical pattern chart having a light shielding portion and an opening portion, a typical image sensor composed of a matrix of 5 (H)×4 (V), and G pixels arranged on the image sensor, which shows a case where the boundary line between the light shielding portion and opening portion of the pattern chart does not exist on the G pixel contained in a frame r; and

FIG. 20 is a block diagram showing a configuration of a camera 50 obtained by adding a thinning-out control section 44 to the camera 30 according to the second embodiment of the present invention.

### DETAILED DESCRIPTION OF THE INVENTION

Embodiments of the present invention will be described below with reference to the accompanying drawings.

### First Embodiment

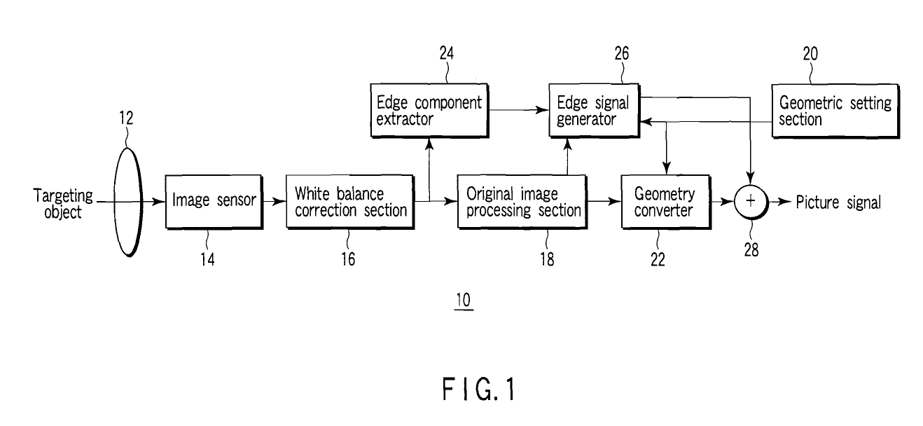

FIG. 1 is a block diagram showing a configuration of a camera according to a first embodiment of the present invention.

In FIG. 1, a camera 10 includes an optical system 12, an image sensor 14, a white balance correction section 16, an original image processing section 18, a geometric setting section 20, a geometry converter 22, an edge component extractor 24, an edge signal generator 26, and an image synthesizer 28.

The optical system 12 generates an optic image from a targeting object. The image sensor 14 photoelectric converts the optic image generated in the optical system 12 to generate a output signal from image sensor. The white balance correction section 16 corrects the white balance of the output signal from image sensor to generate a white balanced imaging signal. The original image processing section 18 generates an original picture signal from the white balanced imaging signal. These components are used in a typical camera.

The geometric setting section 20 sets a desired geometric transformation for the original picture signal. The geometry converter 22 generates a geometrically converted picture signal from the original picture signal based on the geometric setting made by the geometric setting section 20. These components are also used in a typical camera.

The edge component extractor 24 extracts edges of the image from the white balanced imaging signal or a single color output signal from image sensor obtained from the output signal from image sensor. The edge signal generator 26 generates a signal at the edges from the edges of the image. The image synthesizer 28 synthesizes the geometrically converted picture signal and signal at the edges to generate a picture signal. These components constitute a signal at the edges generation section included in the camera according to the present embodiment.

The image sensor 14 may be a plurality of photoelectric conversion devices such as a CCD or MOS image sensor. The photoelectric conversion device may be a photodiode or amorphous image sensor.

The image sensor 14 may be a single plate image sensor, and a color filter of a plurality of colors may be provided for each opening corresponding to an image capture pixel. Array of the color filters may be arranged in a Bayer array or in a color-difference checkered array. The array of the color filters may be variously modified.

Alternatively, a configuration may be adopted in which an optical prism is provided in the optical system 12 so as to separate an optic image into a plurality of color (wavelength) components and, then, a multi-plate image sensor is provided for each color. The plates of the image sensor 14 may be arranged using a “pixel matching method” or may be arranged using a “pixel shift method”. Further, the image sensor 14 may be a Foveon's direct-image-sensor.

An extraction method by the edges of the image extractor in the present embodiment will be described.

The edge component extractor 24 uses different extraction methods depending on the type of the image sensor 14. The extraction method includes an all-colors extraction method, a single color extraction method, a thinning-out single color extraction method, and an applied method based on these methods.

The all-colors extraction method is edges of the image extraction method suitably applied to the color filter method using the single plate image sensor. In the system using the optical prism provided in the optical system, the all-colors extraction method is suitably applied to the pixel shift method using the multi-plate image sensor.

In the all-colors extraction method, the white balance correction section 16 shown in FIG. 1 corrects the white balance of a output signal from image sensor generated by the image sensor 14 to obtain a white balanced imaging signal. After that, respective colors are treated as equivalent edges of the images without performing luminance matrix operation.

For example, in the case of the single plate image sensor using color filters arranged in an RGB Bayer array, the extraction is carried out as follows. That is, the captured image is multiplied by a gain for each RGB color to correct the white balance, and R pixel signal, G pixel signal, and B pixel signal are defined as equivalent YH pixel signals. After that, an edge extraction filter is applied to the YH pixel signals to extract the edges of the image.

The edge component extractor 24 may be a digital filter having a cut-off frequency for extracting edges of the image including adjacent two pixels or adjacent three pixels.

Coring limit that rounds off a small amplitude component or level dependence that limits the amplitude of a large amplitude component may be applied to the edges of the image thus obtained.

As described above, the all-colors extraction method is featured in that the R, G, and B pixel signals are defined as YH pixels so that the effective number of pixels of the captured image and the number of pixels serving as candidate for the edges of the image extraction coincide with each other. With this feature, the single plate type camera can be made comparable to a three-plate type camera (pixel matching method) in terms of the resolution and frequency modulation of contrast of the captured image.

The single color extraction method will next be described.

The single color extraction method is edges of the image extraction method suitably applied to a white-and-black method (including infrared imaging) using the single plate image sensor, pixel matching method in the multi-plate image sensor provided with the optical prism, or Foveon's direct-image-sensor system.

In the single color extraction method, the white balance correction section 16 shown in FIG. 1 need not necessarily be provided but may be omitted. This is because the single color extraction method extracts the edges of the image from a single color output signal from image sensor obtained from the output signal from image sensor. Alternatively, the edge component extractor 24 may be connected to the front stage of the white balance correction section 16.

For example, in the case of the pixel matching method using an RGB three-plate image sensor, a G pixel signal is defined as the YH pixel signal, and the abovementioned edge extraction filter is applied to the YH pixel signal to obtain edges of the image.

Coring limit that rounds off a small amplitude component or level dependence that limits the amplitude of a large amplitude component may be applied to the edges of the image thus obtained.

As the thinning-out single color extraction method, there are edges of the image extraction methods suitably applied to the color filter method using the single plate image sensor or pixel shift method in the multi-plate image sensor provided with the optical prism. These methods can be realized at lower cost and on a smaller scale and are more suitable for the purpose of reducing time lag between capturing of an optic image and display of the captured image than the all-colors extraction method. This thinning-out single color extraction method is also a concrete example of the edge extraction method for a high-speed electronic viewfinder (EVF). Details of the thinning-out single color extraction method will be described later in a second embodiment.

Next, the concept of the edges of the image extracted by the all-colors extraction method and single-color extraction method will be described.

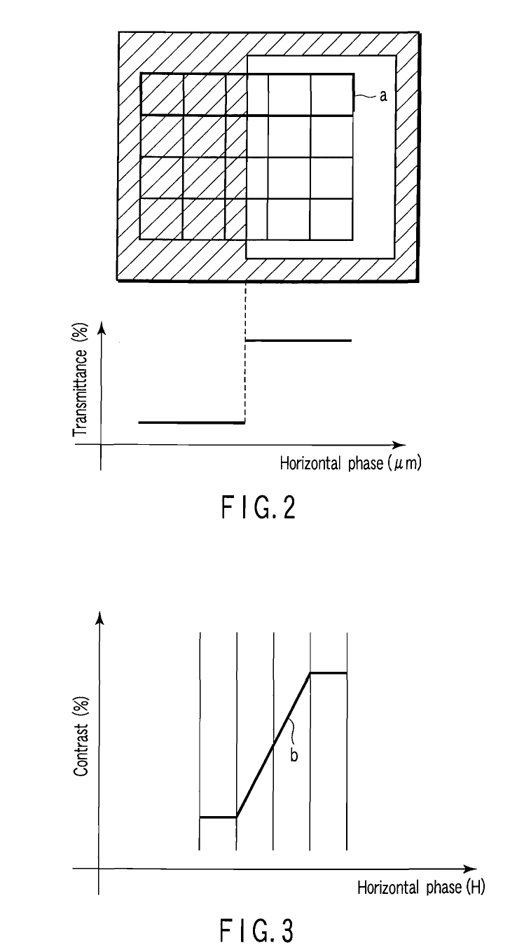

FIG. 2 is a conceptual view showing a relationship among an optic image of a typical pattern chart having a light shielding portion and an opening portion, a partially shown image sensor composed of a matrix of 5 (H)×4 (V), and a graph representing the transmittance (%) of the pattern chart with respect to the horizontal phase (μm) of the image sensor.

FIG. 2 is a conceptual view used for explaining the present embodiment, and MTF degradation of the optical system (optical LPF) is not reflected in the optic image of the pattern chart. However, even if the MTF degradation occurs, the intended effect of the present invention can be obtained.

In FIG. 2, the boundary line between the light shielding portion and opening portion of the optic image of the pattern chart is located at substantially the center of the third column (H) of the image sensor. When focusing on five pixels arranged in the horizontal direction, which are denoted by a frame a, the closer the edges of the image extracted from output signal from image sensor generated by the five pixels to the characteristics of the graph representing the transmittance (%) which is shown in FIG. 2, the higher the reproducibility of the edges of the image becomes.

FIG. 3 is a graph representing the contrast (%) of a output signal from image sensor b generated by the horizontally arranged five pixels (H) denoted by the frame a in FIG. 2.

In FIG. 3, vertical lines (H) in the graph are set in such a manner that the horizontal phase (μm) (phase corresponding to the face center of the actual pixel to be captured) corresponds to the horizontal pixel unit (H).

As shown in the graph of FIG. 3, the waveform shape of the image (contrast of the output signal from image sensor b) to be actually captured differs from that of the transmittance (%) of the pattern chart shown in FIG. 2. This is because that the boundary line (substantially the center of the third column (H) of the image sensor) between the light shielding portion and opening portion of the optic image of the pattern chart is captured (sampled) in such a manner as if it is positioned at substantially the intermediate level of the contrast.

In FIG. 3, a differential signal of the contrast of the output signal from image sensor corresponding to the adjacent pixels (2 (H) to 4 (H)) and phase (H) thereof correspond to the edges of the image (transient area of edge line) in the present embodiment. Thus, even if a targeting object (and optic image) has a rectangular shape, the edges of the image thereof is captured by three pixels in many cases.

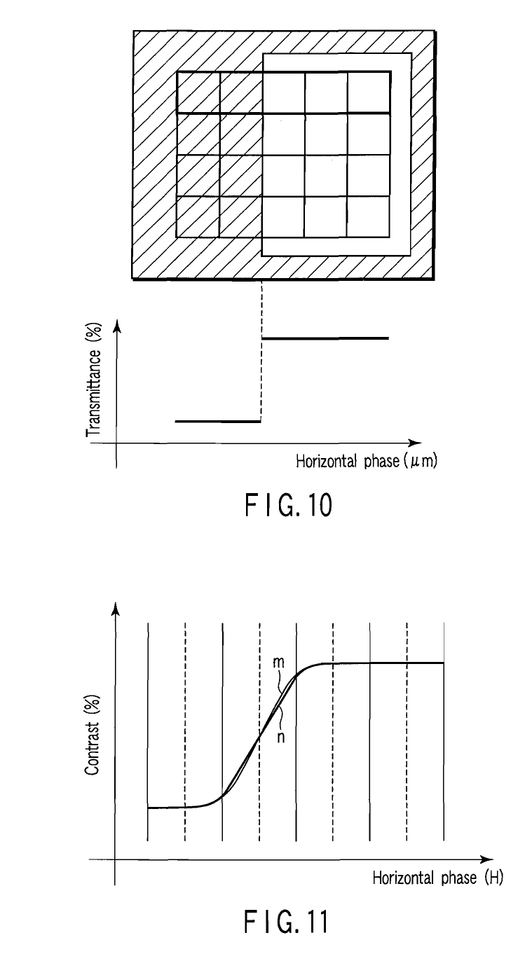

In the case where the boundary line of the optic image of the pattern chart substantially corresponds to the boundary line between adjacent pixels, the edges of the image is captured by two pixels in some cases. However, whether or not the boundary line of the optic image of the pattern chart substantially corresponds to the boundary line between adjacent pixels is incidental. The cases where the edges of the image is captured by two pixels will be described later (see FIGS. 10, 11, and 12).

Next, the edge signal generator 26 in the present embodiment will be described.

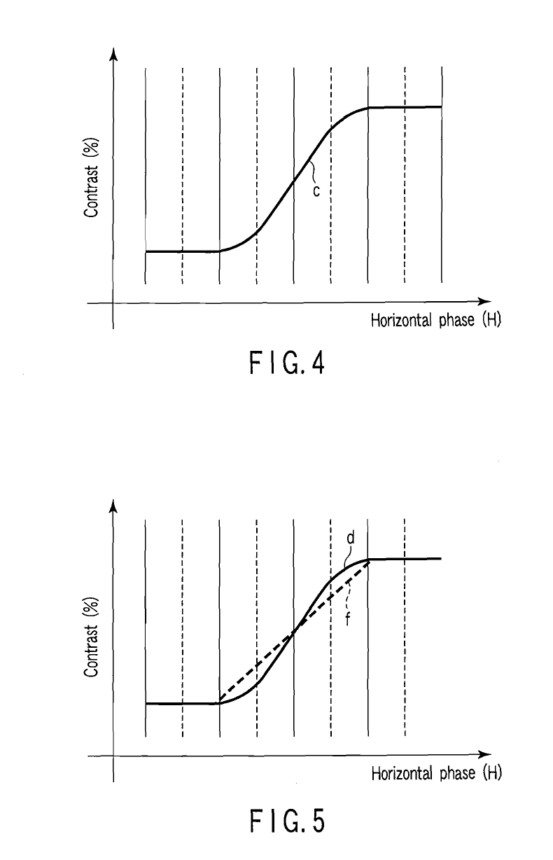

FIG. 4 is a graph representing the contrast (%) of a output signal from image sensor c whose phase is doubled in the horizontal direction by applying assistant pixels interval to the output signal from image sensor b shown in FIG. 3 according to a typical bicubic assistant pixels interval formula.

In FIG. 4, solid lines (H) represent the horizontal phase (H) of the contrast (%) of the output signal from image sensor shown in FIG. 3, and broken lines (H) between the solid lines represent the horizontal phase of the interpolated picture signal obtained by interpolating pixels into the output signal from image sensor.

The edge signal generator 26 generates a signal at the edges from the abovementioned edges of the image. It is assumed that the edge signal generator 26 generates the signal at the edges by applying assistant pixels interval according to a typical bicubic assistant pixels interval formula. In this case, as shown in FIG. 4, the number of adjacent pixels included in the edges of the image (transient area of the edge line) is increased from three (including no interpolated image) to five (including two interpolated pixels). That is, when the output signal from image sensor is expanded by assistant pixels interval, the edges of the image is also expanded by being subjected to the assistant pixels interval.

As described above, the waveform generated by applying assistant pixels interval according to a typical bicubic assistant pixels interval formula to the edges of the image largely differs from the waveform of the actual image (e.g., the waveform of the transmittance of the pattern chart shown in FIG. 2) of a targeting object. That is, a bold line image that has not originally existed in the actual image of a targeting object is visually emphasized, which is unnatural to human eyes.

Therefore, the edge signal generator 26 performs control so as to alleviate expansion of the width of the edges of the image in association with magnification (including magnification of a part of a captured image) of the entire captured image and thereby to prevent the signal at the edges of the captured image from being unnatural to human eyes.

FIG. 5 is a graph representing, in a superimposed manner, the contrast (%) of a signal at the edges d which is obtained by applying the assistant pixels interval according to a typical bicubic assistant pixels interval formula to the output signal from image sensor shown in FIG. 3 and contrast (%) of a signal at the edges f which is obtained by assistant pixels interval according to a typical bilinear assistant pixels interval formula thereto.

In FIG. 5, when focusing a difference between the assistant pixels interval according to the bicubic assistant pixels interval formula and that according to the bilinear assistant pixels interval formula, it can be seen that the contrast (%) obtained by the assistant pixels interval according to the bicubic assistant pixels interval formula is closer to the characteristics of the graph representing the transmittance (%) of the pattern chart which is shown in FIG. 2.

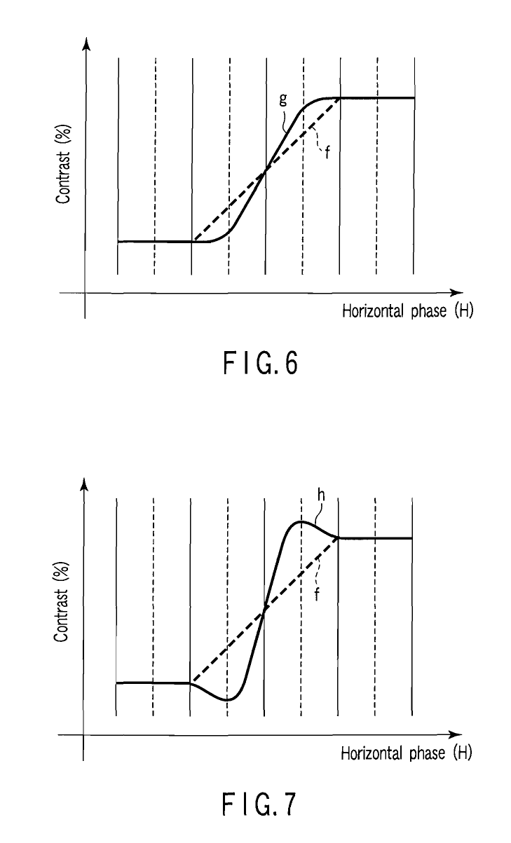

FIG. 6 is a graph representing, in a superimposed manner, the contrast (%) of a signal at the edges g obtained by assistant pixels interval based on parameter control in the first embodiment of the present invention and contrast (%) of a signal at the edges f which is obtained by assistant pixels interval according to the typical bilinear assistant pixels interval formula.

The curves in the graph shown in FIG. 6 are the result of a parameter operation according to the following equation (1).

I(x,y)=P(e,z)×{Ic(x,y)−IL(x,y)}+IL(x,y) (1)

x is a variable representing horizontal phase (H); y is a variable representing vertical phase (V); z is a variable representing magnification to zoom an image (×Z) based on the geometric setting in the present embodiment; e is enhancement at the edges coefficient to emphasize edges; I (x,y) is assistant pixels interval value based on the parameter control in the present embodiment; P (e,z) is geometry parameter controlled based on the geometric setting in the present embodiment; Ic (x,y) is assistant pixels interval value based on the typical bicubic assistant pixels interval formula; and IL (x,y) is assistant pixels interval value based on the typical bilinear assistant pixels interval formula. It is assumed that the coefficient to emphasize edges e in the graph shown in FIG. 6 is set to e0.

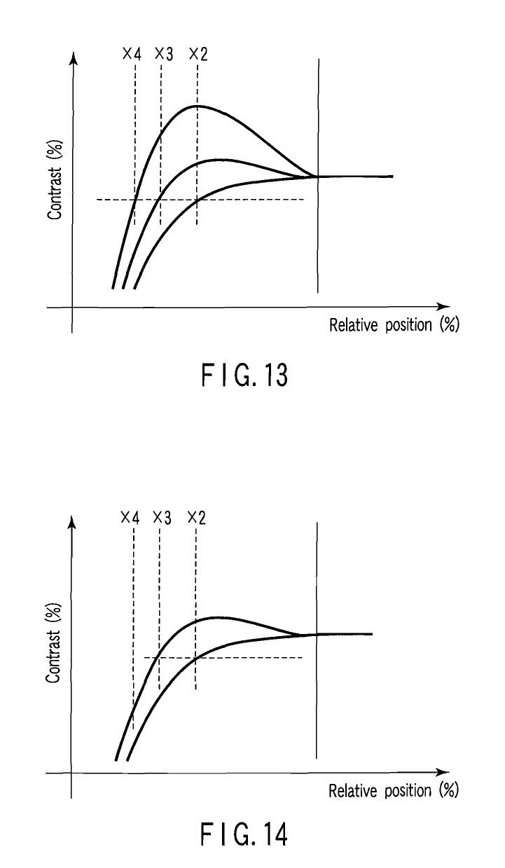

As described above, the assistant pixels interval value I (x,y) based on the parameter control in the first embodiment includes the assistant pixels interval value Ic (x,y) based on the bicubic assistant pixels interval formula, assistant pixels interval value IL (x,y) based on the bilinear assistant pixels interval formula, and geometry parameter P (e,z) controlled based on the geometric setting. A concrete method for controlling the magnification to zoom an image (×Z) which is one of variables for determining the geometry parameter P (e,z) will be described later (see FIGS. 13 and 14).

FIG. 7 is a graph representing, in a superimposed manner, the contrast (%) of a signal at the edges h obtained by assistant pixels interval based on enhancement at the edges type parameter control in the first embodiment and contrast (%) of a signal at the edges f which is obtained by assistant pixels interval according to the typical bilinear assistant pixels interval formula.

In FIG. 7, the assistant pixels interval value I (x,y) is obtained by assigning e=e1 to the geometry parameter P (e,z) shown in the equation (1). Even if the magnification to zoom an image z=2 (×2) is set based on the same geometric setting in both the graphs of FIGS. 6 and 7, a comparison between them reveals that P (e0, 2)<P (e1, 2). Thus, the geometry parameter P (e,z) includes the coefficient to emphasize edges e for controlling the enhancement amount of the signal at the edges, in addition to the magnification to zoom an image z (×z) based on the geometric setting.

That is, for example, in a camera that records and displays a captured image, the coefficient to emphasize edges e for record is set to e0 so as to make the recorded image natural to human eyes. In this state, the coefficient to emphasize edges e for display may be changed to e1 to previously enhance the signal at the edges so as to facilitate focusing control or focusing check.

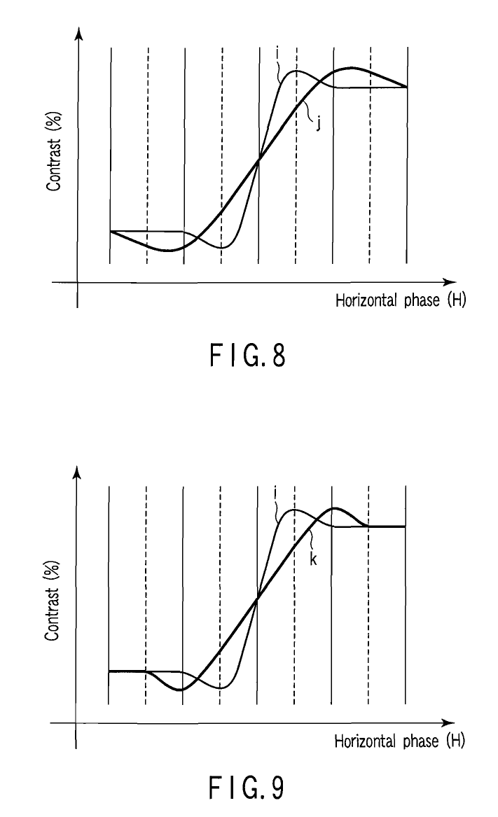

FIG. 8 is a graph representing, in a superimposed manner, the contrast (%) of a signal at the edges i obtained by the enhancement at the edges based on the enhancement at the edges type parameter in the present embodiment which is shown in FIG. 7 and contrast (%) of a signal at the edges j which is obtained by a typical enhancement at the edges (bold line).

When the contrast (%) of the signal at the edges obtained by the typical enhancement at the edges and contrast (%) of the signal at the edges obtained by the enhancement at the edges based on the enhancement at the edges type parameter in the present embodiment are compared to each other, the enhancement at the edges amounts (differences in the contrast) substantially coincide with each other. However, the width (H) of the edges of the image (transient area of the edge line) is 2 H in the case of the signal at the edges according to the present embodiment; while the width is 4 H in the case of the typical signal at the edges.

This shows that the signal at the edges according to the present embodiment is closer to the characteristics of the graph representing the transmittance (%) of the pattern chart which is shown in FIG. 2 than the typical signal at the edges. That is, the signal at the edges according to the present embodiment has higher reproducibility of the actual image of a targeting object.

FIG. 9 is a graph representing, in a superimposed manner, the contrast (%) of a signal at the edges i obtained by the enhancement at the edges based on the enhancement at the edges type parameter in the present embodiment which is shown in FIG. 7 and contrast (%) of a signal at the edges k which is obtained by applying enhancement at the edges processing after image magnification processing.

When the typical signal at the edges (bold line) k and typical edge line (bold line) j shown in FIG. 8 are compared to each other, it can be seen that they have different line thicknesses in the edge enhanced portions thereof. The edge enhanced portion shown in FIG. 8 includes 2 H, while the edge enhanced portion in FIG. 9 includes only 1 H. Thus, improvement is achieved with regard to the expansion of the edge enhanced portion in association with the image magnification processing.

However, edges of the image (transient area of edge line) that has already been contained in the captured image must be a part of the image, so that the width of the edges of the image is expanded in proportion to the magnification to zoom an image z (×z) in the typical signal at the edges obtained by applying the enhancement at the edges shown in FIG. 9 after the image magnification processing.

As shown in FIG. 9, even if the enhancement at the edges is applied to the edges of the image (2H) of the signal at the edges according to the first embodiment after the image magnification processing, the edges of the image of the signal at the edges includes 4 H.

As described above, the signal at the edges generator 26 according to the first embodiment of the present invention alleviates expansion of the width of the edges of the image (transient area of the edge line) in proportion to the magnification to zoom an image z (×z) of the captured image set based on the geometric transformation to thereby prevent the signal at the edges of the captured image from being unnatural to human eyes.

Next, a case where the edges of the image of the edge signal generator 26 according to the first embodiment of the present invention is captured by two pixels will be described.

FIG. 10 is a conceptual view showing a relationship among an optic image of a typical pattern chart having a light shielding portion and an opening portion, a partially shown image sensor composed of a matrix of 5 (H)×4 (V), and a graph representing the transmittance (%) of the pattern chart with respect to the horizontal phase (μm) of the image sensor, which shows a case where the boundary line between the light shielding portion and opening portion of the pattern chart substantially corresponds to the boundary line between adjacent pixels on the image sensor.

As shown in FIG. 10, the boundary line between the light shielding portion and opening portion of the pattern chart is not always positioned at the face center of the pixel as shown in FIG. 2.

FIG. 11 is a graph representing, in a superimposed manner, the contrast (%) of a signal at the edges m which is obtained based on horizontal assistant pixels interval value Ic (x) according to the typical bicubic type assistant pixels interval formula and contrast (%) of a signal at the edges n which is obtained based on horizontal assistant pixels interval value IL (x) according to the typical bilinear type assistant pixels interval formula under the image capture condition shown in the conceptual view of FIG. 10.

In FIG. 11, when focusing the difference between the horizontal assistant pixels interval value Ic (x) according to the typical bicubic type assistant pixels interval formula and horizontal assistant pixels interval value IL (x) according to the typical bilinear type assistant pixels interval formula, it can be seen that although the horizontal assistant pixels interval value Ic (x) is slightly closer to the characteristics of the graph representing the transmittance (%) of the pattern chart which is shown in FIG. 10, the difference between the two is not so large as in the case of FIG. 5 where the edges of the image is captured by three pixels (including two interpolated pixels).

This shows that, in the equation (1),

Ic(x,y)−IL(x,y)≈0

and therefore,

I(x,y)≈IL(x,y) is satisfied.

As described above, in the case where the boundary line of the optic image of the pattern chart substantially corresponds to the boundary line between the adjacent pixels on the image sensor, the edges of the image is captured by two pixels. Whether the boundary line of the optic image of the pattern chart substantially corresponds to the boundary line between adjacent pixels or exists on the pixels is incidental.

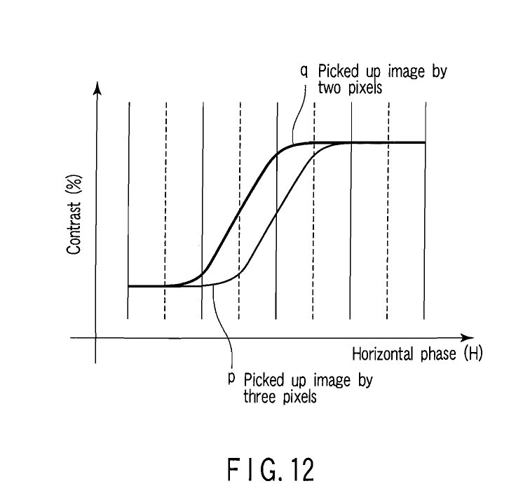

FIG. 12 is a graph representing, in a superimposed manner, the contrast (%) of a signal at the edges p which is obtained based on the horizontal assistant pixels interval value I (x) according to the present invention in the case of FIG. 6 where the edges of the image is captured by three pixels and contrast (%) of a signal at the edges q which is obtained based on the horizontal assistant pixels interval value I (x) according to the first embodiment in the case of FIG. 11 where the edges of the image is captured by two pixels.

As shown in FIG. 12, the edge signal generator according to the present embodiment can generate edges of the images having substantially the same waveform irrespective of whether the edges of the image is captured by three pixels or two pixels.

However, it should be noted that in the case of the graph as shown in FIG. 7 which is obtained by assigning the coefficient to emphasize edges e=e1 to the geometry parameter P (e,z), the waveforms of the edges of the images are not substantially the same. It can be considered a method in which assistant pixels interval of an enhancement at the edges type based on e=e1 in the above equation (1) is applied in the case where the coefficient to emphasize edges e is used in an electric viewfinder (EVF) and assistant pixels interval of an enhancement at the edges type based on e=e0 is applied at the recording time of the captured image.

Next, a concrete control method performed by the geometric setting means of the edge signal generator 26 according to the first embodiment of the present invention will be described.

As described above, the geometric transformation includes various application forms according to purpose such as electronic zoom (magnification), electronic camera shake correction (magnification and rotation), optical distortion correction, and aspect ratio conversion (horizontal magnification or vertical magnification). Further, the edge signal generator 26 alleviates expansion of the width of the edges of the image in proportion to the magnification to zoom an image z (×z) of the captured image (including magnification of a part of a captured image) set based on the geometric transformation to thereby prevent the signal at the edges of the captured image from being unnatural to human eyes.

Referring to FIG. 1, it can be seen that the geometric setting section 20 and edge signal generator 26 are connected to each other. With this configuration, the magnification to zoom an image (×z) based on the geometric setting is input to the edge signal generator 26, whereby the geometry parameter P (e,z) can be defined.

The geometry parameter P (e,z) is a parameter that can control the degree of the enhancement at the edges in forming an image based on the coefficient to emphasize edges e=e0 and e=e1 and is characterized by parameter-controlling the assistant pixels interval value I (x, y) for generating the signal at the edges from the edges of the image whose frequency is decreased in accordance with the magnification to zoom an image z (×z) based on the geometric setting.

FIG. 13 is a graph showing a relationship between the relative position (%) of a captured image based on the magnification to zoom an image (×z) and contrast (%) of the signal at the edges according to the first embodiment.

In FIG. 13, “×2” denotes the magnification to zoom an image z based on the geometric setting=2 (×2), “×3” denotes the magnification to zoom an image z based on the geometric setting=3 (×3), and “×4” denotes the magnification to zoom an image z based on the geometric setting=4 (×4). The magnification to zoom an image z (×z) may be applied not only to the magnification of the entire captured image but also magnification of a part of the captured image.

As shown in FIG. 13, the value of the geometry parameter P (e,z) should be increased as the magnification to zoom an image z (×z) based on the geometric setting becomes greater. This is, when the substantial number of luminance samples of the image capture pixel becomes insufficient due to the geometric transformation, the apparent resolution or sharpness of the captured image is impaired. When the value of the geometry parameter P (e,z) is increased as the magnification to zoom an image z (×z) based on the geometric setting becomes greater as described above, the degradation of the apparent resolution or sharpness of the captured image can be visually corrected, resulting in improvement in the image quality.

FIG. 14 is a graph showing a relationship between the relative position (%) of an image capture pixel based on the magnification to zoom an image (×z) and contrast (%) of the signal at the edges according to the present embodiment, in which the magnification to zoom an image z in the geometry parameter P (e,z) is set to 3 or less.

As shown in FIG. 14, the value of the geometry parameter P (e,z) is increased as the magnification factor z (×z) based on the geometric setting becomes greater. However, when the magnification factor z (×z) exceeds 3, the z in the geometry parameter P (e,z) is not increased but kept at 3 (×3).

In the graph of FIG. 13, the contrast (%) of the edges of the image is maintained even in the case where the magnification to zoom an image z is set to 4 (×4) as described above. At the same time, however, adversely there occurs an adverse effect that an overshoot component is generated in the edges of the image. That is, although the apparent resolution or sharpness is improved, the overshoot component becomes unnatural to human eyes.

In order to cope with this problem, limit control is applied to the geometry parameter P (e,z) such that the magnification to zoom an image z in the geometry parameter P (e,z) is set to 3 or less as shown in the graph of FIG. 14. As a result, when the magnification factor z (×z) exceeds 3, although the apparent resolution or sharpness is impaired, it is possible to prevent generation of unnecessary overshoot component.

It should be noted that the above limit control is not for the magnification to zoom an image with respect to the captured image or edges of the image but for the geometry parameter (e,z).

The edge signal generator 26 according to the present embodiment is not for increasing the resolution of the picture itself but for improving apparent resolution, so that the control of the geometry parameter P (e,z) should be performed with an importance placed on the apparent image quality.

The valid range of the geometry parameter P (e,z) and the degree of the enhancement at the edges of the geometry parameter P (e,z) can be set variously in accordance with the balance between an image sensor and display section (EVF, etc.) or in terms of the merchantability of a camera.

As described above, according to the first embodiment, there can be provided a camera capable of improving the apparent resolution or sharpness of a captured image which is impaired in association with the degradation of the resolution of the picture due to the geometric transformation applied for the captured image.

Further, according to the first embodiment, there can be provided a camera capable of alleviating expansion of the width of the edges of the image in proportion to the magnification to zoom an image z (×z) (including magnification of a part of a captured image) of the captured image set based on the geometric transformation to thereby prevent the signal at the edges of the captured image from being unnatural to human eyes.

Further, according to the first embodiment, there can be provided a camera incorporating a geometric transformation function which is moderate in price, which has a small-scale circuit, and which has a smaller time lag between capturing of an optic image and display of the captured image so as to visually confirm a result of geometric transformation in substantially a real-time manner through an electronic viewfinder (EVF) or a small-sized monitor provided in the camera before and during recording of the captured image.

### Second Embodiment

A second embodiment of the present invention will be described below.

The second embodiment of the present invention is a camera having a configuration in which the edges of the image extractor shown in the first embodiment according to the thinning-out single color extraction method is made conforming to, e.g., a high-speed electronic viewfinder (EVF).

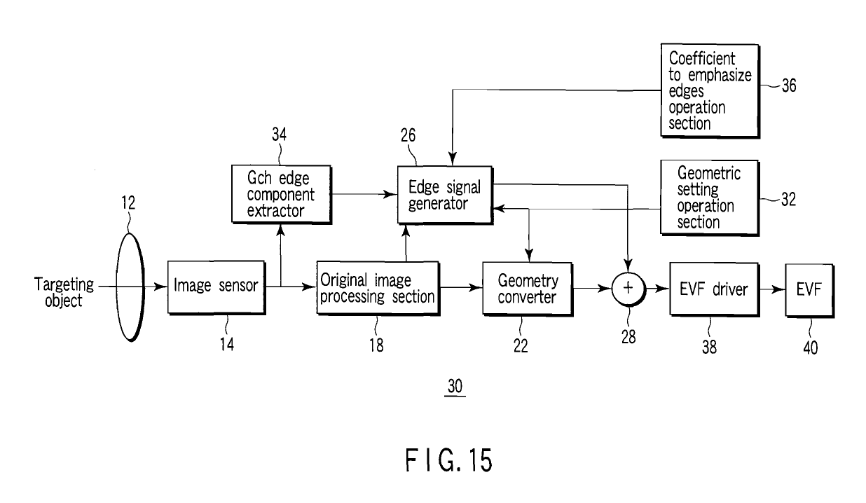

FIG. 15 is a block diagram showing a configuration of a camera according to the second embodiment of the present invention.

The basic configuration and operation of the camera according to the second embodiment are the same as those of the camera according to the first embodiment shown in FIG. 1. Thus, in FIG. 15, the same reference numerals as those in FIG. 1 are used for the same parts as those in FIG. 1, and the descriptions thereof will be omitted and different configuration and different operation from the first embodiment will be described.

In FIG. 15, a camera 30 includes an optical system 12, an image sensor 14, an original image processing section 18, a geometry converter 22, a geometric setting operation section (geometric setting means) 32, a Gch edge component extractor 34, an edge signal generator 26, a coefficient to emphasize edges operation section 36, an image synthesizer 28, an image display driver (EVF driver) 38, and an electronic viewfinder (EVF) 40.

Although the configurations of the optical system 12, image sensor 14, original image processing section 18, geometric setting operation section 32, geometry converter 22, edge signal generator 26, and image synthesizer 28 may be the same as those shown in the first embodiment, the original image processing section 18 typically includes the white balance correction section 16 shown in the first embodiment.

The image display driver 38 generates, from a picture signal obtained by synthesizing a geometrically converted picture signal and signal at the edges, a typical image display signal for displaying on the electronic viewfinder 40.

The electronic viewfinder 40 is a small-sized monitor for visually confirming a targeting object image in substantially a real time manner before and during recording of the captured image, which is provided in a typical camera.

The Gch edge component extractor 34, which is obtained by substituting the edge component extractor 24 into a concrete example of the thinning-out single color extraction method, is a thinning-out extractor for Gch pixels. The Gch edge component extractor 34 is suitably applied to an RGB Bayer array in a single plate image sensor or RGB pixel shift in a multi-plate image sensor provided with an optical prism.

For example, in the case of the single plate image sensor whose color filters are arranged in the RGB Bayer array, the Gch edge component extractor 34 extracts only a G pixel signal, defines the extracted G signal as a YH pixel signal, and applies an edge extraction filter to the YH pixel signal to thereby extract the edges of the image.

Further, in the case of the RGB Bayer array in the single plate image sensor, the Gch edge component extractor 34 extracts only G pixels, defines the extracted G pixels as a YH pixel signal, and applies an edge extraction filter to the YH pixel signal to thereby extract the edges of the image. The GH pixel signal is a signal used for the edges of the image and is not allowed to function as color information as G color.

The edge extraction filter may be a digital filter having a cut-off frequency for extracting edges of the image from G pixels each composed of two pixels arranged at one-pixel intervals or G pixels each composed of three pixels arranged at one-pixel intervals.

Further, when the original image processing section 18 and edge signal generator 26 are connected in parallel as shown in FIG. 15, it is possible to increase image processing speed of the camera to thereby display an image by the edge signal generator 26 being connected to the original image processing section 18 in a parallel circuit configuration more quickly than in the case where a serial circuit configuration in which the edge signal generator 26 is connected to the rear stage of the original image processing section 18.

In a typical camera of recent years, the number of pixels of the electronic viewfinder tends to be smaller than the number of pixels of the image sensor, so that all RGB pixels need not necessarily be required for edges of the image extraction but only the G pixels may suffice in some cases. By extracting only the G pixels as the edges of the image, it is possible to increase image processing speed of the edge signal extractor, as well as to reduce the circuit scale thereof.

The coefficient to emphasize edges operation section 36 is an operation section for a user to control the coefficient to emphasize edges e1 for display which is described in the first embodiment. The coefficient to emphasize edges operation section 36 is called “peaking volume” in a typical camera for broadcasting use and is provided to the electronic viewfinder 40 in some cases.

The coefficient to emphasize edges operation section 36 is operated for, e.g., a coefficient for display (coefficient for EVF) of the coefficient to emphasize edges and need not necessarily be reflected in a coefficient for record of a captured image.

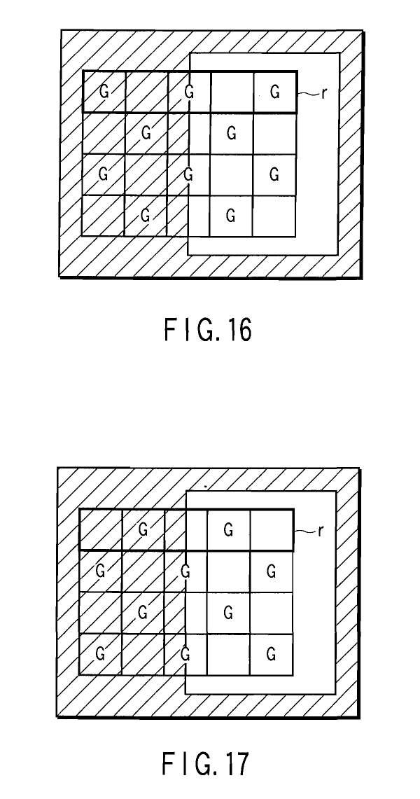

FIG. 16 is a view showing a relationship among an optic image of a typical pattern chart having a light shielding portion and an opening portion, a partially shown image sensor composed of a matrix of 5 (H)×4 (V), and G pixels arranged on the image sensor.

FIG. 16 is a conceptual view for explaining the second embodiment of the present invention, and MTF degradation of the optical system (optical LPF) is not reflected in the optic image of the pattern chart.

In FIG. 16, when the relationship with respect to the horizontal phase (H) between the optic image of this pattern chart and output signal from image sensor based on the G pixels of the image sensor is estimated using horizontally arranged five pixels denoted by a frame r, it is supposed to be equivalent to the edges of the image composed of the center three pixels of the graph shown in FIG. 3.

Therefore, in the case where the relationship with respect to the horizontal phase (H) between the optic image of the pattern chart and G pixels is as shown in FIG. 16, the same signal at the edges as that shown in FIG. 6 or FIG. 7 can be obtained. However, in the case of the RGB Bayer array, the number of G pixels becomes half the total number of RGB pixels, so that the number of samples of a signal at the edges that can be obtained becomes about the half.

Next, a case where the relationship with respect to the horizontal phase (H) between the optic image of the pattern chart and G pixels is not as shown in FIG. 16 will be described.

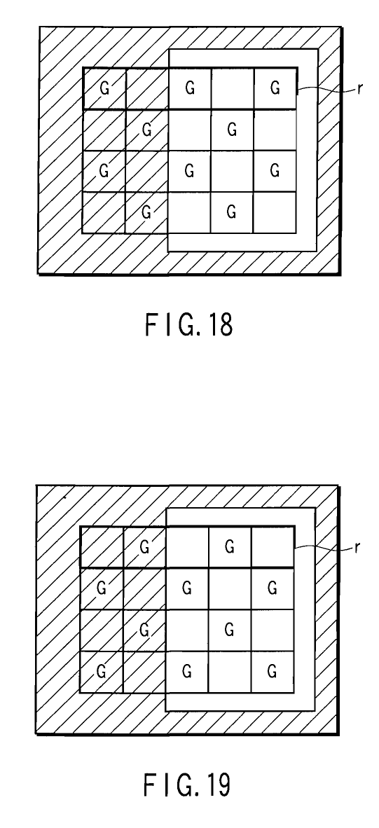

FIGS. 17, 18, and 19 are views showing a relationship between an optic image of a typical pattern chart having a light shielding portion and an opening portion, a typical image sensor composed of a matrix of 5 (H)×4 (V), and G pixels arranged on the image sensor, which shows a case where the boundary line between the light shielding portion and opening portion of the pattern chart does not exist on the G pixel contained in a frame r.

In FIGS. 17, 18, and 19, when the relationship with respect to the horizontal phase (H) between the optic image of this pattern chart and contrast (%) of a signal at the edges obtained after capturing the optic image by the G pixels is estimated using horizontally arranged five pixels denoted by the frame r in FIGS. 17, 18, and 20, it can be seen that they are equivalent to the conceptual view of FIG. 10 and graph of FIG. 11. However, in the case of the RGB Bayer array, the number of G pixels becomes half the total number of RGB pixels, so that the number of samples of a signal at the edges that can be obtained becomes about half.

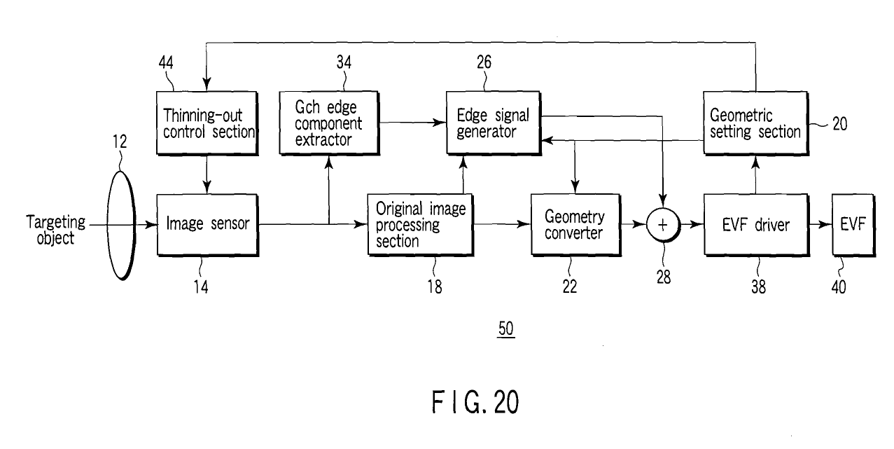

FIG. 20 is a block diagram showing a configuration of a camera 50 obtained by adding a thinning-out control section 44 to the camera 30 according to the second embodiment of the present invention.

The thinning-out control section 44 selects thinning-out reading of pixels of the image sensor 14 and/or thinning-out reading of lines thereof based on the geometric setting output from the geometric setting section 20.

The thinning-out control section 44 reads out, in a thinning-out manner, effective pixels from physically available pixels of the image sensor 14, thereby increasing the frame rate for image capture. The thinning-out control section 44 has an object to enable variable frame rate image capture or high-speed EVF output appropriate for visual feature of human eyes.

As shown in the block diagram of FIG. 20, the operation of the thinning-out control section 44 is based on the geometric setting output from the geometric setting section 20, and the same is true of the operation of the abovementioned edge signal generator 26. Therefore, the geometric transformation is consistent between the thinning-out control section 44 and edge signal generator 26. This is because that the geometry parameter P (e,z) is created depending on the thinning-out condition of the image sensor 14.

As described above, the camera 30 according to the second embodiment extracts only G pixels as the edges of the image and performs thinning-out reading of the image sensor 14 to enable high-speed image processing of the edge signal generator 26 while retaining the function that the camera 10 according to the first embodiment has. Thus, the camera 30 can be said to be a specialized camera for a high-speed electronic viewfinder (EVF).

Therefore, as described above, according to the second embodiment, there can be provided a camera capable of improving the apparent resolution or sharpness of a captured image which is impaired in association with the degradation of the resolution of the picture due to the geometric transformation applied for the captured image.

Further, according to the second embodiment, there can be provided a camera capable of alleviating expansion of the width of the edges of the image in proportion to the magnification to zoom an image z (×z) (including magnification of a part of a captured image) of the captured image set based on the geometric transformation to thereby prevent the signal at the edges of the captured image from being unnatural to human eyes.

Further, according to the second embodiment, there can be provided a camera incorporating a geometric transformation function which is moderate in price, which has a small-scale circuit, and which has a smaller time lag between capturing of an optic image and display of the captured image so as to visually confirm a result of geometric transformation in substantially a real-time manner through an electronic viewfinder (EVF) before and during recording of the captured image.

While certain embodiments of the inventions have been described with reference to the accompanying drawings, the concrete configurations are not limited to the above embodiments, and various modifications may be made without departing from the scope of the technical idea of the present invention.

Further, the above embodiment includes various-step inventions and, by properly combining the plurality of constituent requirements disclosed, various inventions can be extracted. For example, in the case where the problems can be solved and intended effects can be obtained even if some constituent requirements are deleted from all constituent requirements disclosed in the embodiments, the construction in which the constituent requirements are deleted can be extracted as an invention.

According to the present invention, it is possible to improve the apparent resolution or sharpness of a captured image which is impaired in association with the degradation of the resolution of the picture due to the geometric transformation applied for the captured image.

Further, according to the present invention, it is possible to alleviate expansion of the width of the edges of the image in association with magnification (including magnification of a part of a captured image) of the entire captured image and thereby to prevent the edges of the image of the captured image from being unnaturally be emphasized.

Further, according to the second embodiment, it is possible to incorporate, in a camera, a geometric transformation apparatus which is moderate in price, which has a small-scale circuit, and which has a smaller time lag between capturing of an optic image and display of the captured image so as to visually confirm a result of geometric transformation in substantially a real-time manner through an electronic viewfinder (EVF) or a small-sized monitor provided in the camera before and during recording of the captured image.

In addition, when the present invention is applied to a single plate image sensor, it can be made comparable to a three-plate type camera (pixel matching method) in terms of the resolution and frequency modulation of contrast of the captured image.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A camera comprising:
an optical section which generates an optic image from a targeting object;
an image sensor which photoelectric converts the optic image to generate an output signal from the image sensor;
a white balance correction section which corrects the white balance of the output signal from the image sensor to generate a white balanced imaging signal;
an original image processing section which generates an original picture signal from the white balanced imaging signal;
a geometric setting section which sets a desired geometric transformation for the original picture signal;
a geometry converter which generates a geometrically converted picture signal based on the geometric setting made by the geometric setting section;
an edge component extractor which extracts edges of the image from the output signal from the image sensor;
an edge signal generator which generates a signal at the edges from the edges of the image; and
an image synthesizer which synthesizes the geometrically converted picture signal and signal at the edges to generate a picture signal, wherein
the edge signal generator performs geometrical transformation of the edges of the image based on the geometric setting and is parameter-controlled based on a geometry parameter computed from a coefficient to emphasize edges for controlling the enhancement at the edges amount for the edges of the image and magnification to zoom an image calculated based on the geometric setting.

2. The camera according to claim 1, wherein
the geometry parameter is a parameter related to a difference formula between a bicubic type image interpolation formula for computing bicubic type assistant pixels interval and bilinear type assistant pixels interval formula for computing bilinear type assistant pixels interval formula.

3. The camera according to claim 1, wherein,
in the case where the magnification to zoom an image is set equal to or less than a predetermined value, the geometry parameter is generated based on the set magnification to zoom an image, while in the case where the magnification to zoom an image exceeds the predetermined value, the geometry parameter is generated based on the predetermined value.

4. The camera according to claim 1, wherein
the coefficient to emphasize edges includes a plurality of types of coefficients including, at least, a coefficient for record of the picture signal and coefficient for display of the picture signal.

5. The camera according to claim 4, further comprising a coefficient to emphasize edges operation section for operating the coefficient to emphasize edges, wherein
the coefficient to emphasize edges operation section is operated for the coefficient for display and, as the coefficient for record, a fixed value is input.

6. The camera according to claim 1, wherein
the edge component extractor includes an edge extraction filter having a cut-off frequency for extracting the edges of the image composed of adjacent two pixels or adjacent three pixels arranged on the image sensor, wherein
the edge extraction filter is applied to the white balanced imaging signal so as to extract the edges of the image.

7. The camera according to claim 1, wherein
RGB color filters are arranged in a Bayer array in the image sensor,
the edge component extractor includes an edge extraction filter having a cut-off frequency for extracting the edges of the image from two G color pixels arranged at one-pixel intervals on the image sensor or three G color pixels arranged at one-pixel intervals thereon, and
the edge extraction filter is applied to the output signal from image sensor so as to extract the edges of the image.

8. The camera according to claim 6, wherein
the edge component extractor further includes coring limit for rounding off a small amplitude component of the edges of the image or level dependence for limiting the amplitude of a large amplitude component of the edges of the image.

9. The camera according to claim 7, wherein
the edge component extractor further includes coring limit for rounding off a small amplitude component of the edges of the image or level dependence for limiting the amplitude of a large amplitude component of the edges of the image.
